(19) United States
(12) Patent Application Publication
(10) Pub. No.: US 2026/0276792 A1
(43) Pub. Date: Sep. 17, 2026

(54) SPAD ARRAY LIDAR, VEHICLE INCLUDING THE SAME AND METHOD OF CONTROLLING SPAD ARRAY LIDAR

(71) Applicant: LG INNOTEK CO., LTD., Seoul (KR)

(72) Inventors: Jaewook JUNG, Seoul (KR); Sangwoo KIM, Seoul (KR); Taewoo LEE, Seoul (KR); Kyungdeok SONG, Seoul (KR); Joonhyung KIM, Seoul (KR)

(73) Assignee: LG INNOTEK CO., LTD., Seoul (KR)

(21) Appl. No.: 19/567,530

(22) Filed: Mar. 16, 2026

(30) Foreign Application Priority Data
Mar. 17, 2025 (KR) 10-2025-0034288
Aug. 5, 2025 (KR) 10-2025-0107405

(51) Int. Cl. G01S 7/481

(52) U.S. Cl. CPC G01S 7/4816; G01S 7/4814; G01S 7/4817

(57) ABSTRACT

Provided are a SPAD array LiDAR capable of implementing various vertical angular resolutions by a combination of a SPAD array and a vertical scanner, and a vehicle including the same. A SPAD array LiDAR according to an embodiment of the present disclosure includes: an optical output unit outputting laser light to recognize a measurement target object; an optical sensor including a Single Photon Avalanche Diode (SPAD) array sensing reflected light of the laser light reflected from the measurement target object; and a scanner scanning the laser light and the reflected light. The scanner includes a horizontal scanner scanning the laser light and the reflected light in a horizontal scanning direction; and a vertical scanner scanning the laser light and the reflected light in a vertical scanning direction. The SPAD array includes optical pixels arranged in a plurality of pixel rows and a plurality of pixel columns along the horizontal scanning direction and the vertical scanning direction. The optical pixels are grouped into N pixel lines along the vertical scanning direction, where N is an integer of 2 or more. N, which is the number of the pixel lines, is dynamically set according to LiDAR specifications.

### TECHNICAL FIELD

The present disclosure relates to a LiDAR and a vehicle including the same, and more particularly, to a SPAD array LiDAR having an optical sensor including a Single Photon Avalanche Diode (SPAD) array, a vehicle including the same, and a method of controlling the SPAD array LiDAR.

### BACKGROUND ART

Recently, demand for high-precision distance measurement technology for precisely recognizing surrounding environments is increasing in various fields such as autonomous driving vehicles, drones, industrial robots, and security surveillance systems. To meet such demand, Light Detection and Ranging (LiDAR), which is a distance measurement device using light, is being utilized. Spatial resolution of a LiDAR sensor is a key indicator representing a degree to which a surrounding environment can be sensed in detail. The spatial resolution of the LiDAR sensor may be typically determined by angular resolution. The angular resolution refers to an angular difference between two consecutive measurement points scanned by the LiDAR. As the angular resolution becomes smaller, sensing can be performed at narrower intervals, and a more precise 3D point cloud can be generated.

As one of the methods for improving the angular resolution, a LiDAR using a high-sensitivity Single Photon Avalanche Diode (SPAD) array having a large number of pixels has been proposed. The SPAD is a high-sensitivity light receiving element capable of detecting a single photon, and has an advantage of securing high distance measurement precision even for an object having low reflectivity when combined with a Time-of-Flight (ToF) scheme. The SPAD array can acquire an image at a high speed by arranging a plurality of light receiving elements in parallel, and can improve angular resolution performance of the LiDAR by using a SPAD array having a large number of pixels. In addition, the SPAD array enables independent timing measurement in pixel units, which is advantageous for acquiring a 3D distance image.

The SPAD array-based LiDAR is mainly implemented as a flash LiDAR, or uses a scheme of creating a field of view by horizontally scanning a line beam. However, when the angular resolution is implemented using the SPAD array, there is a limitation in that the angular resolution cannot be variably changed depending on the number of pixels. In addition, since precision of angular resolution obtainable through scanning increases as an interval between laser beams generated by a laser diode increases, optical sensor performance of the SPAD array is affected by specifications of the laser diode.

In the case of a Silicon Photomultiplier (SiPM) in which a plurality of SPADs are connected in parallel, a maximum of 16 channels is a limit, and assuming a field of view of 4.8 degrees, a large number of channels of 96 channels or more are required to achieve an angular resolution of 0.05 degrees. Since the angular resolution of a known SPAD array is at a level of 0.1 degrees, a new technical scheme capable of solving this is required to achieve a more precise angular resolution of 0.05 degrees or less. The background technology described above is intended to explain the background from which the present disclosure was derived, and does not mean that it is prior art known before the filing of the present application.

### SUMMARY OF THE INVENTION

### Technical Problem

An object of the present disclosure is to provide a SPAD array LiDAR capable of implementing various vertical angular resolutions by a combination of a SPAD array and a vertical scanner, a vehicle including the same, and a method of controlling the SPAD array LiDAR.

In addition, another object of the present disclosure is to provide a SPAD array vertical scanner LiDAR that implements vertical scanning by dynamically setting pixel lines of a SPAD array according to LiDAR specifications including laser diode specifications, a vehicle including the same, and a method of controlling the SPAD array LiDAR.

The technical problems to be solved by the present disclosure are not limited to the technical problems set forth above, and other technical problems not mentioned will be clearly understood by those skilled in the art from the following description.

### Solution to the Problem

A SPAD array LiDAR according to an embodiment of the present disclosure includes: an optical output unit configured to output laser light toward a measurement target object to recognize the measurement target object; an optical sensor including a Single Photon Avalanche Diode (SPAD) array configured to sense reflected light of the laser light reflected from the measurement target object; and a scanner configured to scan the laser light and the reflected light.

The scanner includes: a horizontal scanner configured to scan the laser light and the reflected light in a horizontal scanning direction; and a vertical scanner configured to scan the laser light and the reflected light in a vertical scanning direction. The SPAD array includes optical pixels arranged in a plurality of pixel rows and a plurality of pixel columns along the horizontal scanning direction and the vertical scanning direction. The optical pixels are grouped into N pixel lines along the vertical scanning direction, where Nis an integer of 2 or more. The number (N) of the pixel lines, is dynamically set according to LiDAR specifications.

The LiDAR specifications may include laser diode specifications.

The pixel lines may be grouped such that each pixel line includes optical pixels arranged in M consecutive pixel columns, where M is 2 or more.

The pixel lines do not overlap each other in the horizontal scanning direction of the scanner, and the pixel lines may be divided such that no pixel column remains between adjacently arranged pixel lines.

The pixel lines may be activated by being sequentially synchronized with consecutive N vertical scanning periods, where N is 2 or more.

Each pixel line may include: active pixels arranged in a region corresponding to a sparse beam among optical pixels arranged along the horizontal scanning direction and activated for distance measurement with respect to the measurement target object; and spare pixels arranged in a region not corresponding to the sparse beam and not used for the distance measurement with respect to the measurement target object.

The pixel lines may be configured such that the active pixels sequentially activated according to vertical scanning do not overlap each other in the vertical scanning direction between the pixel lines.

The spare pixels are configured to receive an external light signal, and the external light signal may be used as preprocessing data for noise reduction.

A ratio of the active pixels among the optical pixels of each grouped pixel line may be set to be inversely proportional to the number of the grouped pixel lines.

The SPAD array may be variably set such that the number of the pixel lines is 2, 3, or 4 or more according to the LiDAR specifications.

The LiDAR specifications may include a reference specification, a high specification higher than the reference specification, and a low specification lower than the reference specification. When the LiDAR specification is the reference specification, the number of the pixel lines may be set to a reference pixel line number. When the LiDAR specification is the high specification, the number of the pixel lines may be set to a first pixel line number larger than the reference pixel line number. When the LiDAR specification is the low specification, the number of the pixel lines may be set to a second pixel line number smaller than the reference pixel line number.

When the LiDAR specification is the reference specification, the optical pixels may be grouped into three pixel lines. When the LiDAR specification is the low specification, the optical pixels may be grouped into two pixel lines. When the LiDAR specification is the high specification, the optical pixels may be grouped into four or more pixel lines.

The number of optical pixels included in each grouped pixel line when the LiDAR specification is the low specification may be greater than the number of optical pixels included in each grouped pixel line when the LiDAR specification is the reference specification.

The number of optical pixels included in each grouped pixel line when the LiDAR specification is the high specification may be smaller than the number of optical pixels included in each grouped pixel line when the LiDAR specification is the reference specification.

The laser diode specification may be determined based on at least one of a beam divergence angle, energy density, a pulse width, and output power of the optical output unit.

The LiDAR specifications may be determined based on a beam divergence angle of a laser diode, energy density, a pulse width, output power, a Vertical Field of View (FoV), Horizontal Point Spacing, Vertical Point Spacing, a Number of channels, Points per second, a maximum detection range, and a type of the SPAD array.

The SPAD array LiDAR according to an embodiment of the present disclosure may further include a controller configured to control the optical sensor. The controller may set the number of the pixel lines according to the LiDAR specification including the laser diode specification and performance of the detector.

The controller may group the pixel lines into a reference pixel line number when the performance of the detector is within a set reference performance range; and may decrease the number of the grouped pixel lines to be smaller than the reference pixel line number when the performance of the detector is lowered below the reference performance range.

In addition, according to an embodiment of the present disclosure, a vehicle equipped with the SPAD array LiDAR is provided.

In addition, according to an embodiment of the present disclosure, provided is a method of controlling a SPAD array LiDAR including an optical output unit, an optical sensor, and a scanner, the method comprising: outputting, by the optical output unit, laser light toward a measurement target object to recognize the measurement target object; sensing, by the optical sensor including a Single Photon Avalanche Diode (SPAD) array, reflected light of the laser light reflected from the measurement target object; scanning, by the scanner, the laser light and the reflected light; and grouping, by a controller including at least one processor, the optical pixels into N pixel lines along the vertical scanning direction, where N is an integer of 2 or more (wherein N, which is the number of the pixel lines, is dynamically set according to a LiDAR specification including a laser diode specification).

### Advantageous Effects

According to an embodiment of the present disclosure, a SPAD array LiDAR capable of implementing various vertical angular resolutions by a combination of a SPAD array and a vertical scanner, a vehicle including the same, and a method of controlling the SPAD array LiDAR may be provided.

In addition, according to an embodiment of the present disclosure, vertical scanning of the LiDAR can be implemented by dynamically setting pixel lines of the SPAD array according to LiDAR specifications such as laser diode specifications.

The effects desired to be achieved by the present disclosure are not limited to the effects mentioned above, and other effects not mentioned will be clearly understood by those skilled in the art from the following description.

### BRIEF DESCRIPTION OF DRAWINGS

FIG. 1 is a schematic drawing of a SPAD array LiDAR and a vehicle including the same according to an embodiment of the present disclosure.

FIG. 2 is a perspective view illustrating a SPAD array LiDAR according to an embodiment of the present disclosure.

FIG. 3 is a configuration diagram illustrating a SPAD array LiDAR according to an embodiment of the present disclosure.

FIG. 4 is a conceptual diagram for explaining horizontal scanning and vertical scanning operations of a SPAD array LiDAR according to an embodiment of the present disclosure.

FIGS. 5 to 7 are conceptual diagrams illustrating that a SPAD array according to an embodiment of the present disclosure is grouped into a plurality of pixel lines, and the plurality of pixel lines of the SPAD array operate sequentially in synchronization with vertical scanning of the LiDAR.

FIG. 8 is a flowchart illustrating an operation of a SPAD array LiDAR according to an embodiment of the present disclosure.

FIG. 9 is a flowchart illustrating a process of grouping pixel lines of a SPAD array according to a LiDAR specification in more detail.

### DETAILED DESCRIPTION OF THE INVENTION

Since the present disclosure may apply various changes and have various embodiments, specific embodiments will be illustrated in the drawings and described. However, this is not intended to limit the present disclosure to specific embodiments, and should be understood to include all modifications, equivalents, or substitutes included in the technical spirit and scope of the present disclosure. That is, expressions such as “for example” or “exemplarily” used in the present specification are for describing specific embodiments, and should not be construed as limiting the scope of the present disclosure.

The technical spirit of the present disclosure is not limited to some embodiments described, and may be implemented in various different forms, and it should be understood that new embodiments in which one or more of the components between the embodiments are selectively combined or substituted to be used within the scope of the technical spirit of the present disclosure are also included in the present disclosure. Each component described as an integral part may be implemented as separate components, and similarly, components described as multiple components may also be implemented as an integral part.

It is noted that the drawings are schematic and not drawn to scale. The relative dimensions and proportions of parts in the drawings may be exaggerated or reduced for clarity and convenience, and any dimensions illustrated are merely exemplary and not intended to be limiting. In addition, when identical structures, elements, or parts appear in more than one drawing, the same reference numerals are used to indicate similar features where possible.

In addition, terms (including technical and scientific terms) used in the embodiments of the present disclosure should be interpreted as meanings that can be generally understood by those skilled in the art to which the present disclosure pertains, unless explicitly defined and described, and terms generally used, such as terms defined in a dictionary, should be interpreted in consideration of the meanings in the context described in the present disclosure. If a term defined in a commonly used dictionary does not match the meaning it has in the context of the description of the present disclosure, it should be interpreted as having the meaning it has in the context of the description of the present disclosure, and even if it is not explicitly defined in this application, it should not be interpreted in an overly formal meaning based on the description of the present disclosure.

Additionally, the terms used in the embodiments of the present disclosure are for the purpose of describing the embodiments and are not intended to limit the present disclosure. In some embodiments, well-known process steps, well-known device structures, or well-known technologies are not described in detail in order to avoid obscuring the present disclosure. Additionally, in this specification, singular forms may also include plural forms unless specifically stated otherwise.

Terms that include ordinal numbers, such as ‘first’ and ‘second’, can be used to describe various components, but the components are not limited in meaning by their ordinal numbers. Terms containing ordinal numbers are used only to distinguish one component from another and are not limited by the nature, order, or sequence of the components. For example, without departing from the scope of the present disclosure, the second component may be referred to as the first component, and similarly, the first component may also be referred to as the second component. In addition, even if ordinals such as first and second are excluded, if the meaning of the component does not go beyond the scope of the present disclosure, the component may be referred to excluding the ordinal number.

The term “and/or” is interpreted to mean that one or more or all of the listed components may be included, for example, “A and/or B” should be understood to include all instances where A alone, B alone, or both A and B are included. In this application, terms such as “includes,” “is provided,” “has,” and “consists of” are intended to designate the presence of a feature, number, step, operation, component, part, or combination thereof described herein, and should be understood as not precluding the presence or addition of one or more other features, numbers, steps, operations, components, parts, or combinations thereof.

When referring to a direction, a vertical direction and a horizontal direction are used for convenience of description. In addition, the horizontal direction may include a first horizontal direction perpendicular to the vertical direction, and a second horizontal direction perpendicular to the first horizontal direction and the vertical direction. In addition, when the vertical direction and the horizontal direction follow a Cartesian coordinate system, they may correspond to a first horizontal direction (X-axis), a second horizontal direction (Y-axis), and a vertical direction (Z-axis), respectively; when following a cylindrical coordinate system, the first horizontal direction may mean an azimuth (@) direction (or circumferential direction), and the second horizontal direction may mean a radius (ρ) direction (or centrifugal direction) spaced apart from a specific configuration; and when following a spherical coordinate system, the first horizontal direction may mean an azimuth (Φ) direction (or circumferential direction), the second horizontal direction may mean a radius (r) direction (or centrifugal direction) spaced apart from a specific configuration, and in particular, the vertical direction may mean a polar angle (θ) direction formed by the second horizontal direction and the Z-axis.

For convenience of description, the first horizontal direction, the second horizontal direction, and the vertical direction may use a part or a combination of the above-described Cartesian coordinate system, cylindrical coordinate system, and spherical coordinate system. However, unless otherwise specified, the vertical direction means the Z-axis according to the Cartesian coordinate system, and the horizontal direction means all directions definable on the X-Y plane of the Cartesian coordinate system. Exemplarily, when referring to the first horizontal direction and the second horizontal direction perpendicular to the first horizontal direction, the first horizontal direction means the X-axis, and the second horizontal direction means the Y-axis.

Additionally, when it is described as being formed or arranged ‘above or below’ each component, ‘above’ or ‘below’ includes not only cases where the two components are in direct contact with each other, but also cases where one or more other components are formed or arranged between the two components. Additionally, when expressed as ‘upper’ or ‘lower’, it can include the meaning of not only the upward direction but also the downward direction based on one component.

Additionally, the meaning that configuration A is disposed between configuration B and configuration C may mean that configuration A is located in the horizontal space between configuration B and configuration C, and/or in the vertical space between configuration B and configuration C. Furthermore, the meaning that configuration A is disposed between configuration B and configuration C may also include the meaning that configuration A is disposed so that it overlaps configuration B and configuration C at least partially in the vertical and/or horizontal directions. Unless otherwise specified, a configuration C may be included in the meaning of being disposed between configuration A and configuration B even if the configuration C is located between an imaginary line extending vertically and/or horizontally from configuration A and an imaginary line extending vertically and/or horizontally from configuration B.

Additionally, when a component is described as being “connected”, “coupled”, “joined”, or “contacted” to another component, it may include not only cases where the component is directly connected, coupled, or joined to the other component, but also cases where the component is “connected”, “coupled”, “joined”, or “contacted” to the other component via another component between the component and the other component. Therefore, if the component A is to be understood only as being directly ‘connected’, ‘coupled’, ‘joined’, or ‘in contact with’ the component B, it is described as being ‘directly connected’, ‘directly coupled’, ‘directly joined’, or ‘in direct contact’.

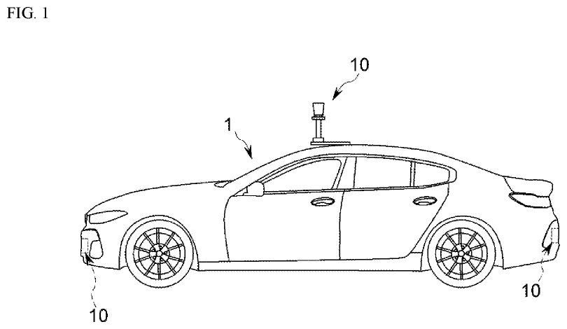

FIG. 1 is a schematic drawing of a SPAD array LiDAR and a vehicle including the same according to an embodiment of the present disclosure. Referring to FIG. 1, a SPAD array LiDAR 10 may be mounted on a vehicle 1, for example. In this case, the SPAD array LiDAR 10 may be mounted inside or outside the vehicle 1. The SPAD array LiDAR 10 may be mounted on the vehicle 1, such as an autonomous driving vehicle, to sense a surrounding environment, but is not limited thereto, and may be applied to various fields such as a drone, an industrial robot, and a security surveillance system.

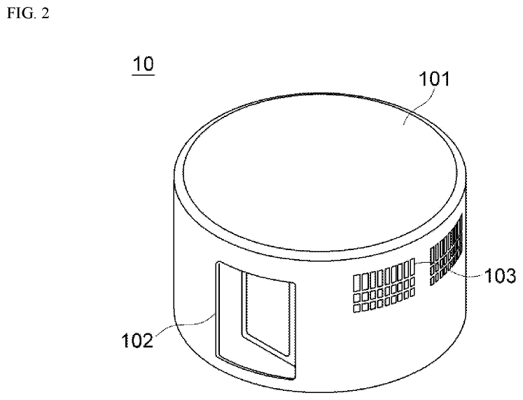

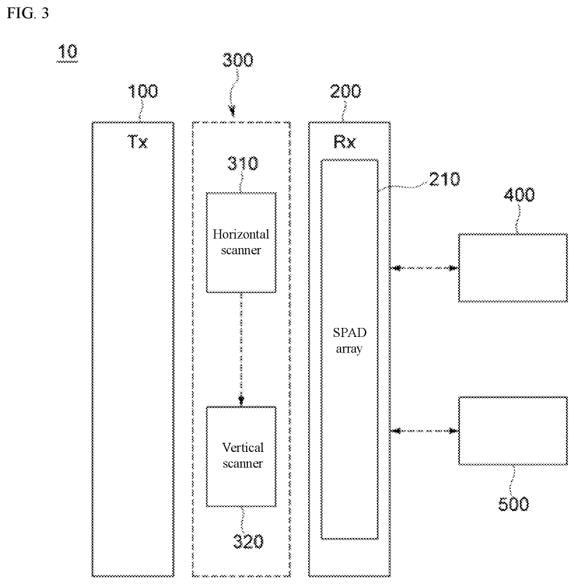

FIG. 2 is a perspective view illustrating a SPAD array LiDAR according to an embodiment of the present disclosure. FIG. 3 is a configuration diagram illustrating a SPAD array LiDAR according to an embodiment of the present disclosure. Referring to FIGS. 1 to 3, the SPAD array LiDAR 10 according to the embodiment of the present disclosure may include a housing 101, and an optical output unit 100, an optical sensor 200, a scanner 300, a controller 400, and a detector 500 installed in the housing 101.

The housing 101 may include an optical path 102 through which laser light output from the optical output unit 100 and reflected light received by reflecting the laser light from a measurement target object may pass. In addition, the housing 101 may include a heat dissipation opening 103 for dissipating heat generated from the SPAD array LiDAR 10.

The optical output unit 100 may be a light emitting unit that outputs the laser light toward the measurement target object to recognize the measurement target object. The measurement target object may be an object such as a car, a bus, a motorcycle, a pedestrian, a bicycle, a kickboard, a road structure (a guardrail, a traffic light, a sign, a sidewalk block, and the like), a road surface, a lane, a pothole, an environmental element (a curb, a ditch, a parking meter, a tree, and the like), a fixed obstacle (a building, a wall, a fence, and the like), a logistics box, a pallet, a part of a production line, a material, a working robot and a peripheral machine, a dimension measurement target (a workpiece), a mountain, a valley, a hill, a structure, an infrastructure structure, a bridge, a railroad, a transmission tower, a pipe, a duct, a fixed structure, a statue, and a mural, but is not limited thereto, and the measurement target object may be variously changed according to an application field and a use.

The optical output unit 100 may generate and output the laser light (output light) in a form of a pulse wave, a continuous wave, or the like. The continuous wave may be in a form of a sinusoid wave, a squared wave, or the like. The optical output unit 100 may include a laser light source and a lens unit. The laser light source may generate and output the laser light such as a laser pulse. The laser light source may include a Laser Diode (LD). The laser light source may include, for example, a Vertical Cavity Surface Emitting Laser (VCSEL) that converts an electrical signal into an optical signal. The laser light source may output the laser light having a wavelength of, for example, 800 to 1000 nm.

The lens unit of the optical output unit 100 may condense and output the laser light output from the laser light source. The lens unit may be disposed on a light output region side of the laser light source. The lens unit may include one or more lenses, and the lenses may be aligned based on a central axis to form an optical system. The central axis may be the same as an optical axis of the optical system. The lens unit may include a diffusion member that receives the laser light output from the laser light source and refracts or diffracts the laser light to output the laser light.

The optical sensor 200 may sense the reflected light of the laser light reflected from the measurement target object. The reflected light may be referred to as input light since the laser light output from the optical output unit 100 reaches the measurement target object, is reflected, returns, and is input to the optical sensor 200. The optical sensor 200 may be a light receiving unit that receives the reflected light reflected and returned from the measurement target object. The optical sensor 200 may include a Single Photon Avalanche Diode (SPAD) array 210. The SPAD array 210 may include optical pixels arranged in a plurality of pixel rows and a plurality of pixel columns along a horizontal scanning direction and a vertical scanning direction.

The optical sensor 200 may be referred to as an image sensor. The optical sensor 200 may include a lens unit including one or more filters and/or one or more lenses disposed on the SPAD array. The reflected light reflected from the measurement target object may pass through the lens unit of the optical sensor 200 and be incident on the SPAD array 210. An optical axis of the lens unit of the optical sensor 200 may be aligned with an optical axis of the image sensor. The filter may be disposed between the lens unit of the optical sensor 200 and the image sensor. The filter may filter light having a predetermined wavelength range and transmit light of a specific wavelength. For example, the filter may transmit light in an infrared band and block light other than the infrared band.

The SPAD array 210 may receive the reflected light, convert the received reflected light into an electrical signal, and output the electrical signal. The SPAD array 210 may sense light of a wavelength corresponding to the wavelength of the laser light output by the optical output unit 100. For example, the SPAD array 210 may sense light in the infrared band. The SPAD array 210 may be provided in a structure in which a plurality of optical pixels are arranged in a grid form.

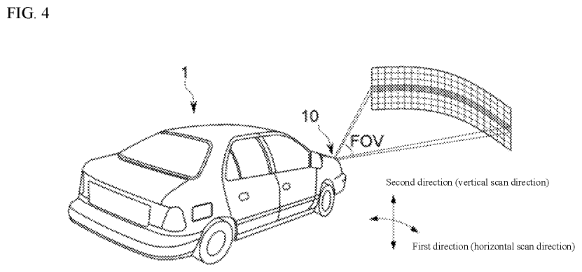

FIG. 4 is a conceptual diagram for explaining horizontal scanning and vertical scanning operations of a SPAD array LiDAR according to an embodiment of the present disclosure. Referring to FIGS. 1 to 4, the optical output unit 100 and the optical sensor 200 may be scan-driven in a horizontal scanning direction (a first direction in FIG. 4) and a vertical scanning direction (a second direction in FIG. 4) by the scanner 300. For example, the vertical scanning direction may be a direction perpendicular to the horizontal scanning direction.

The scanner 300 may scan-drive the laser light and the reflected light in the horizontal scanning direction and the vertical scanning direction. The scanner 300 may include a horizontal scanner 310 and a vertical scanner 320. The horizontal scanner 310 may scan-drive the laser light and the reflected light in the horizontal scanning direction. The vertical scanner 320 may scan-drive the laser light and the reflected light in the vertical scanning direction.

The vertical scanner 320 may perform a function of scanning the laser light in a direction (an up-down direction or a vertical direction) perpendicular to the first direction, which is the horizontal scanning direction of the horizontal scanner 310. The vertical scanner 320 may include, but is not limited to, a mechanical scanner scanning a beam in the vertical direction using a MEMS mirror, a Galvano mirror, or a rotating prism, an optical phased array device electronically scanning a laser beam in the vertical direction through phase control, a polygon mirror which is a polyhedral rotating mirror for vertical scanning, and the like.

The optical sensor 200 may be controlled by the controller 400 to be synchronized with vertical scan driving of the scanner 300. In the present specification, ‘synchronization’ between the optical sensor 200 and the scanner 300 may mean that the reflected light reflected from the measurement target objects in upper and lower regions is temporally synchronized to be incident on the grouped pixel lines of the SPAD array of the optical sensor 200 as the upper and lower regions are sequentially scanned in the second direction by the vertical scanner 320 of the scanner 300.

The controller 400 may group the optical pixels of the SPAD array 210 of the optical sensor 200 into a plurality of pixel lines. In addition, the controller 400 may control to measure the reflected light by sequentially activating the pixel lines in association with the vertical scanning of the scanner 300. That is, the controller 400 may control synchronization between the scanner 300 and the SPAD array 210.

The detector 500 may detect the measurement target object based on a light sensing result of the optical sensor 200. The detector 500 may be an information generation unit generating information on the measurement target object by using a signal of the reflected light input to the optical sensor 200. The detector 500 may detect a time difference (or phase difference) between the laser light output from the optical output unit 100 and the reflected light signal reflected from the measurement target object and incident on the optical sensor 200. The information on the measurement target object may include 3D information (shape information) of the measurement target object. The information on the measurement target object may include, for example, depth information, distance information, and the like of the measurement target object.

The detector 500 may calculate depth information of an object corresponding to the measurement target object by using a flight time taken for the laser light output from the optical output unit 100 to be reflected from the object and input to the optical sensor 200. For example, the detector 500 may calculate a time difference between an output light (laser light) signal and a reception light (input light, reflected light) signal by using an electrical signal generated as the reflected light signal is received from the SPAD array 210, and calculate a distance between the measurement target object and the SPAD array LiDAR 10 by using the calculated time difference. The detector 500 may calculate a phase difference between the output light and the reflected light (reception light) returned by reflecting the output light from the measurement target object, and calculate a distance (depth of the measurement target object) between the measurement target and the LiDAR by using the calculated phase difference.

Driving of the optical output unit 100, the optical sensor 200, the scanner 300, and the detector 500 may be controlled by the controller 400. The controller 400 and/or the detector 500 may be implemented in a form of a printed circuit board (PCB). The controller 400 and/or the detector 500 may be included in a terminal (for example, a vehicle terminal) in which the SPAD array LiDAR 10 is disposed. The controller 400 and/or the detector 500 may be implemented in a form of, for example, an electronic control unit (ECU) of a vehicle on which the SPAD array LiDAR 10 according to the embodiment of the present disclosure is mounted, or an Application Processor (AP) on which the SPAD array LiDAR 10 is mounted.

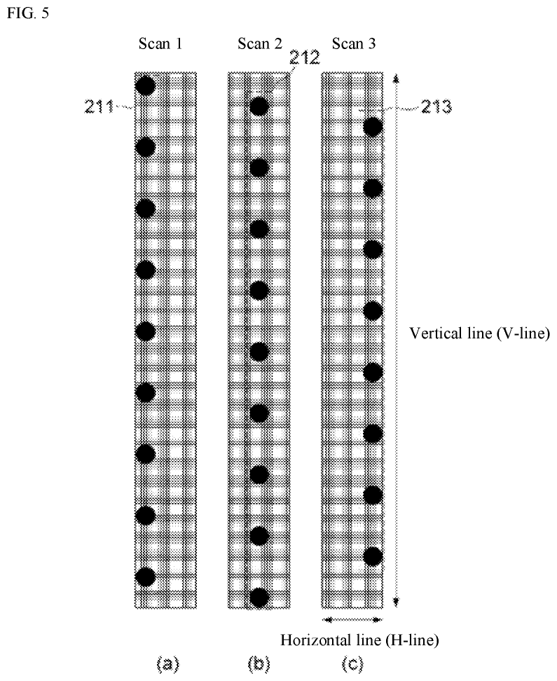

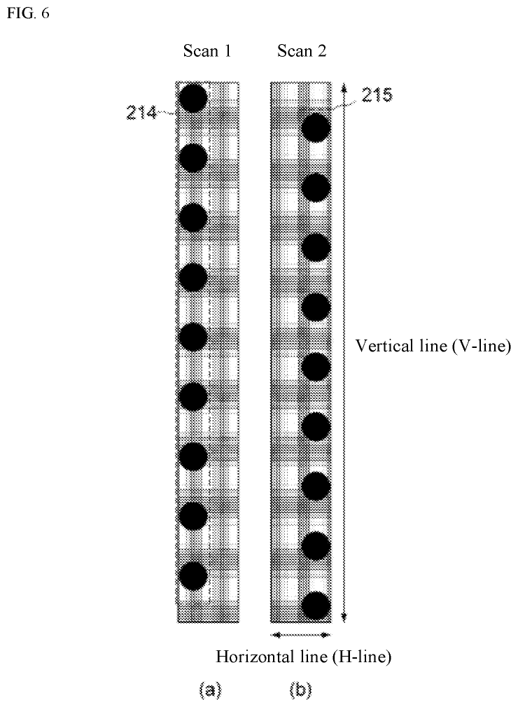

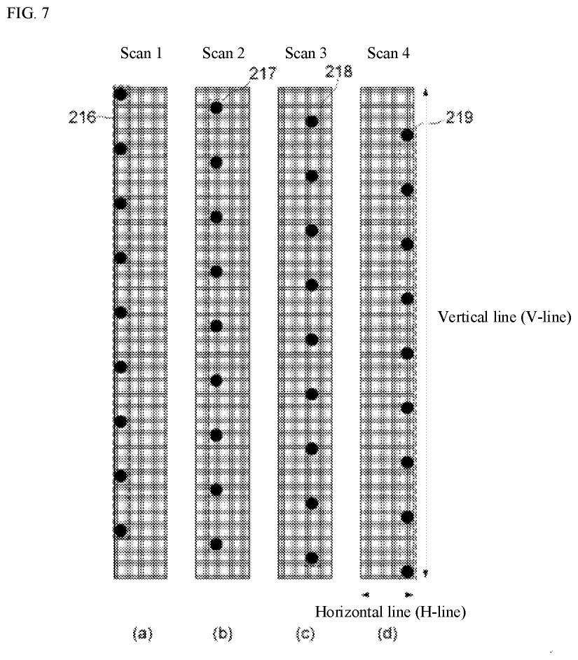

FIGS. 5 to 7 are conceptual diagrams illustrating that a SPAD array according to an embodiment of the present disclosure is grouped into a plurality of pixel lines, and the plurality of pixel lines of the SPAD array operate sequentially in synchronization with vertical scanning of the LiDAR. FIG. 5 is a diagram illustrating that the SPAD array according to the embodiment of the present disclosure is grouped into three pixel lines 211, 212, and 213. FIG. 6 is a diagram illustrating that the SPAD array according to the embodiment of the present disclosure is grouped into two pixel lines 214 and 215. FIG. 7 is a diagram illustrating that the SPAD array according to the embodiment of the present disclosure is grouped into four pixel lines 216, 217, 218, and 219.

Taking a case where the SPAD array 210 is arranged in 56 columns (vertical lines) and 192 rows (horizontal lines) as an example, the SPAD array 210 includes 56×192 optical pixels. In order to obtain an appropriate signal-to-noise ratio, the optical pixels of the SPAD array 210 may be integrated in a binning unit. By converting a group of a plurality of optical pixels into one distance value or signal intensity, reliable distance calculation for the measurement target object may be enabled.

First, taking FIG. 5 as an example, the optical pixels of the SPAD array 210 may be grouped into three pixel lines 211, 212, and 213. FIG. 5 illustrates a grouping result of the pixel lines 211, 212, and 213 when the LiDAR specification including the laser diode specification is a reference specification. When the LiDAR specification is the reference specification, the optical pixels of the SPAD array 210 may be grouped into pixel lines 211, 212, and 213 corresponding to the reference pixel line number (three in the example of FIG. 5).

For example, among the 1st to 56th columns of the SPAD array 210, first optical pixels of the 1st to 18th columns may be grouped into the first pixel line 211, second optical pixels of the 19th to 36th columns may be grouped into the second pixel line 212, and third optical pixels of the 37th to 54th columns may be grouped into the third pixel line 213. In this case, each pixel line 211, 212, and 213 consists of 18×192 optical pixels.

‘Scan 1’ shown in (a) of FIG. 5, ‘Scan 2’ shown in (b) of FIG. 5, and ‘Scan 3’ shown in (c) of FIG. 5 sequentially illustrate that the LiDAR is vertically scanned by the vertical scanner 320. In a ‘scan 1’ section illustrated in (a) of FIG. 5, the first optical pixels included in the first pixel line 211 of the SPAD array 210 are activated by the controller 400 to receive the reflected light, and 3D information on the measurement target object can be obtained based on a signal of the reflected light received by the first optical pixels of the first pixel line 211. At this time, the second pixel line 212 and the third pixel line 213 may be deactivated, or even if activated, reflected light information received by the second pixel line 212 and the third pixel line 213 may not be utilized to generate the 3D information of the measurement target object in the detector 500.

In a ‘scan 2’ section illustrated in (b) of FIG. 5, the second optical pixels included in the second pixel line 212 of the SPAD array 210 are activated by the controller 400 to receive the reflected light, and the 3D information on the measurement target object can be obtained based on a signal of the reflected light received by the second optical pixels of the second pixel line 212. At this time, the first pixel line 211 and the third pixel line 213 may be deactivated, or even if activated, reflected light information received by the first pixel line 211 and the third pixel line 213 may not be utilized to generate the 3D information of the measurement target object in the detector 500.

In a ‘scan 3’ section illustrated in (c) of FIG. 5, the third optical pixels included in the third pixel line 213 of the SPAD array 210 are activated by the controller 400 to receive the reflected light, and the 3D information on the measurement target object can be obtained based on a signal of the reflected light received by the third optical pixels of the third pixel line 213. At this time, the first pixel line 211 and the second pixel line 212 may be deactivated, or even if activated, reflected light information received by the first pixel line 211 and the second pixel line 212 may not be utilized to generate the 3D information of the measurement target object in the detector 500.

Next, referring to FIG. 6, the optical pixels of the SPAD array 210 may be grouped into two pixel lines 214 and 215. FIG. 6 illustrates a grouping result of the pixel lines 214 and 215 when the LiDAR specification including the laser diode specification is a low specification lower than the reference specification. When the LiDAR specification is the low specification, the optical pixels of the SPAD array 210 may be grouped into pixel lines 214 and 215 corresponding to a first pixel line number (two in the example of FIG. 6) smaller than the reference pixel line number (three in the example of FIG. 5).

For example, among the 1st to 56th columns of the SPAD array 210, first optical pixels of the 1st to 28th columns may be grouped into the first pixel line 214, and second optical pixels of the 29th to 56th columns may be grouped into the second pixel line 215. In this case, each pixel line 214 and 215 consists of 28×192 optical pixels. Accordingly, when the LiDAR specification is the low specification, the number of optical pixels included in each pixel line increases compared to the number of optical pixels included in each pixel line when the LiDAR specification is the reference specification.

‘Scan 1’ shown in (a) of FIG. 6 and ‘Scan 2’ shown in (b) of FIG. 6 sequentially illustrate that the LiDAR is vertically scanned by the vertical scanner 320. In a ‘scan 1’ section illustrated in (a) of FIG. 6, the first optical pixels included in the first pixel line 214 of the SPAD array 210 are activated by the controller 400 to receive the reflected light, and the 3D information on the measurement target object can be obtained based on a signal of the reflected light received by the first optical pixels of the first pixel line 214. At this time, the second pixel line 215 may be deactivated, or even if activated, reflected light information received by the second pixel line 215 may not be utilized to generate the 3D information of the measurement target object in the detector 500.

In a ‘scan 2’ section illustrated in (b) of FIG. 6, the second optical pixels included in the second pixel line 215 of the SPAD array 210 are activated by the controller 400 to receive the reflected light, and the 3D information on the measurement target object can be obtained based on a signal of the reflected light received by the second optical pixels of the second pixel line 215. At this time, the first pixel line 214 may be deactivated, or even if activated, reflected light information received by the first pixel line 214 may not be utilized to generate the 3D information of the measurement target object in the detector 500.

Next, taking FIG. 7 as an example, the optical pixels of the SPAD array 210 may be grouped into four pixel lines 216, 217, 218, and 219. FIG. 7 illustrates a grouping result of the pixel lines 216, 217, 218, and 219 when the LiDAR specification including the laser diode specification is a high specification. When the LiDAR specification is the high specification, the optical pixels of the SPAD array 210 may be grouped into four or more pixel lines 216, 217, 218, and 219, which is greater than the reference pixel line number (three in the example of FIG. 5).

For example, among the 1st to 56th columns of the SPAD array 210, first optical pixels of the 1st to 14th columns may be grouped into the first pixel line 216, second optical pixels of the 15th to 28th columns may be grouped into the second pixel line 217, third optical pixels of the 29th to 42nd columns may be grouped into the third pixel line 218, and fourth optical pixels of the 43rd to 56th columns may be grouped into the fourth pixel line 219. In this case, each pixel line 216, 217, 218, and 219 consists of 14×192 optical pixels. Accordingly, when the LiDAR specification is the high specification, the number of optical pixels included in each pixel line decreases compared to the number of optical pixels included in each pixel line when the LiDAR specification is the reference specification.

‘Scan 1’ shown in (a) of FIG. 7, ‘Scan 2’ shown in (b) of FIG. 7, ‘Scan 3’ shown in (c) of FIG. 7, and ‘Scan 4’ shown in (d) of FIG. 7 sequentially illustrate that the LiDAR is vertically scanned by the vertical scanner 320. In a ‘scan 1’ section illustrated in (a) of FIG. 7, the first optical pixels included in the first pixel line 216 of the SPAD array 210 are activated by the controller 400 to receive the reflected light, and the 3D information on the measurement target object can be obtained based on a signal of the reflected light received by the first optical pixels of the first pixel line 216. At this time, the other second to fourth pixel lines 217, 218, and 219 may be deactivated, or even if activated, the received reflected light information may not be utilized to generate the 3D information of the measurement target object in the detector 500.

In a ‘scan 2’ section illustrated in (b) of FIG. 7, the second optical pixels included in the second pixel line 217 of the SPAD array 210 are activated by the controller 400 to receive the reflected light, and the 3D information on the measurement target object can be obtained based on a signal of the reflected light received by the second optical pixels of the second pixel line 217. At this time, the first, third, and fourth pixel lines 216, 218, and 219 may be deactivated, or even if activated, the received reflected light information may not be utilized to generate the 3D information of the measurement target object in the detector 500.

In a ‘scan 3’ section illustrated in (c) of FIG. 7, the third optical pixels included in the third pixel line 218 of the SPAD array 210 are activated by the controller 400 to receive the reflected light, and the 3D information on the measurement target object can be obtained based on a signal of the reflected light received by the third optical pixels of the third pixel line 218. At this time, the first, second, and fourth pixel lines 216, 217, and 219 may be deactivated, or even if activated, the received reflected light information may not be utilized to generate the 3D information of the measurement target object in the detector 500.

In a ‘scan 4’ section illustrated in (d) of FIG. 7, the fourth optical pixels included in the fourth pixel line 219 of the SPAD array 210 are activated by the controller 400 to receive the reflected light, and the 3D information on the measurement target object can be obtained based on a signal of the reflected light received by the fourth optical pixels of the fourth pixel line 219. At this time, the first to third pixel lines 216, 217, and 218 may be deactivated, or even if activated, the received reflected light information may not be utilized to generate the 3D information of the measurement target object in the detector 500.

As described with reference to FIGS. 5 to 7, the optical pixels of the SPAD array 210 may be grouped into N pixel lines 211, 212, and 213 along the vertical scanning direction, where Nis an integer of 2 or more. N, which is the number of the pixel lines 211, 212, and 213, may be dynamically set according to the LiDAR specification. The LiDAR specification may include, for example, a laser diode specification. The laser diode specification may include, for example, a beam divergence angle indicating an angle at which the laser light spreads, an energy density (Energy per Pulse) corresponding to energy per pulse (output×pulse width), a pulse width, and/or output power.

As the beam divergence angle of the laser diode is smaller, a narrower spot size may be formed, and as the beam divergence angle is relatively smaller, the laser diode may be evaluated as having a high specification, and in the opposite case, it may be evaluated as having a low specification. The energy density of the laser diode is a factor affecting a measurement distance and detection reliability, and as the energy density is larger, the laser diode may be evaluated as having a high specification, and in the opposite case, it may be evaluated as having a low specification. As the pulse width of the laser diode is shorter, it may contribute to improvement of distance resolution, and as the output power is higher, it may contribute to an increase in a detection distance. Therefore, as the pulse width and/or the output power of the laser diode is higher, it may be evaluated as having a high specification, and in the opposite case, it may be evaluated as having a low specification.

Referring back to FIG. 5, in order to increase a utilization ratio of the optical pixels of the SPAD array 210, the pixel lines 211, 212, and 213 of the SPAD array 210 may be grouped such that each pixel line 211, 212, and 213 includes optical pixels arranged in M consecutive pixel columns, where M is 2 or more. That is, the first to third pixel lines 211, 212, and 213 may each include optical pixels arranged in 18 consecutive pixel columns. In the example of FIG. 6, each pixel line 214 and 215 may include optical pixels arranged in 28 consecutive pixel columns, and in the example of FIG. 7, each pixel line 216, 217, 218, and 219 may include optical pixels arranged in 14 consecutive pixel columns.

Referring back to FIG. 5, the pixel lines 211, 212, and 213 do not overlap each other in the horizontal scanning direction of the scanner 300, and the pixel lines 211, 212, and 213 may be divided such that no pixel column remains between the adjacently arranged pixel lines 211/212 and 212/213. The pixel lines 211, 212, and 213 may be activated by being sequentially synchronized with N consecutive vertical scanning periods, where N is 2 or more (N=3 in the example of FIG. 5, N=2 in the example of FIG. 6, and N=4 in the example of FIG. 7).

Each pixel line 211, 212, and 213 may include active pixels and spare pixels. The active pixels may be arranged in a region corresponding to a sparse beam among the optical pixels arranged along the horizontal scanning direction. In each pixel line 211, 212, and 213, the active pixels are illustrated as black circles. The active pixels may be activated for distance measurement with respect to the measurement target object. The spare pixels may be arranged in a region not corresponding to the sparse beam. The spare pixels may not be used for the distance measurement with respect to the measurement target object.

When the sparse beam is applied, a LiDAR function can be implemented at high speed by arranging laser beams at intervals within a Field of View (FOV) or lowering a scan density. This provides an advantageous benefit especially when applied to an autonomous driving vehicle. The LiDAR to which the sparse beam is applied may reduce power consumption, reduce data throughput, and acquire 3D information for a wider Field of View (FOV) within the same time. In addition, temperature/heat generation management of the LiDAR is easy, and degradation of LiDAR performance due to heat generation can be prevented. Furthermore, a degree of freedom for aligning the optical output unit within an active region of the optical sensor is increased, thereby reducing difficulty in assembly and processing.

The pixel lines 211, 212, and 213 may be configured such that the active pixels sequentially activated according to the vertical scanning do not overlap each other in the vertical scanning direction between the pixel lines. This may provide an advantage of evenly distributing the active pixels in the SPAD array 210 as a whole, and simultaneously provide an advantageous benefit in obtaining accurate 3D information on the measurement target object.

In an embodiment, a ratio of the active pixels of each pixel line 211, 212, and 213 may be set to 1/N of the optical pixels of the pixel line, where N is the number of the pixel lines. That is, a ratio of the active pixels among the optical pixels of each grouped pixel line 211, 212, and 213 may be set to be inversely proportional to the number N of the grouped pixel lines. For example, as illustrated in FIG. 5, when the pixel lines of the SPAD array 210 are formed in three groups, one-third of optical pixels arranged along a vertical line in each pixel line may be set as the active pixels, and two-thirds of the optical pixels may be set as the spare pixels.

Meanwhile, the spare pixels may be configured to receive an external light signal. The external light signal may be used as preprocessing data for noise reduction. By analyzing a noise signal through the external light signal and removing the noise signal from the reflected light signal obtained by the active pixels based on this, accuracy of obtaining the 3D information on the measurement target object can be improved. As a result that the active pixels are evenly distributed in the plurality of pixel lines 211, 212, and 213, the spare pixels may also be evenly distributed among the plurality of pixel lines 211, 212, and 213. Accordingly, accurate collection of the noise signal may be enabled on an area basis, and noise removal performance may be improved.

The optical sensor 200 may be configured to remove an interference signal by using stereo disparity. A normal reflection signal and a disturbance (interference) signal may be distinguished by observing the same space from two or more viewpoints by the optical sensor 200. This may be usefully utilized in an environment where a plurality of LiDARs exist (for example, an autonomous driving vehicle environment). The stereo disparity refers to a phenomenon in which a position of an object appears differently depending on a LiDAR interval when observing the same scene from two viewpoints. When the stereo disparity is used, a 3D position (distance) of an object may be restored based on triangulation. An interference signal does not match a normal reflected light in a parallax relationship.

The detector 500 may compare disparity consistency between LiDAR reception results of the optical sensor 200, consider an inconsistent signal as interference, and remove the inconsistent signal. For example, the optical sensor is implemented as a dual receiver (or a multiple receiver), receivers disposed on both left and right sides with respect to a laser emitted from the same optical output unit measure distance values, respectively, and a position difference (disparity) of the same object in a point cloud may be calculated based on coordinate systems of the two receivers by Disparity Computation from a reception result. The calculated position difference may be utilized to reconfirm an object distance using a triangulation principle. When signals measured in the same direction of the two receivers do not have disparity consistency (exist only in one receiver or positions of both sides do not correspond), distance estimation values for the same point do not match, or signal patterns do not match (signal meta information such as a pulse width, intensity, and a phase does not match), the signals may be determined as interference signals and removed.

A signal sensed by the optical sensor 200 may be used to distinguish an interference signal from another LiDAR using an encryption pattern. For example, a unique identifier may be assigned to a transmission signal, and the unique identifier may be recognized upon reception to determine a signal having a different source. By assigning a unique pattern, code, or phase to each LiDAR transmitter (Laser Diode, VCSEL, etc.), it is possible to distinguish whether a received signal corresponds to an external interference signal. In this case, Time Coding adjusting transmission timing (pulse interval, period) of a pulse according to a specific sequence, Phase Modulation differentiating a phase or frequency sweep scheme in an FMCW/FMCV scheme, Pseudo-random Code assigning a random number-based code sequence, Signal Encoding (Amplitude, Polarization) assigning a pulse size, polarization, and other physical characteristics, and the like may be utilized.

Referring to FIGS. 1 to 7, the SPAD array may be variably set such that the number of the pixel lines is 3 (see FIG. 5), 2 (see FIG. 6), 4 (see FIG. 7), or more according to the LiDAR specification. Although the SPAD array has been described above as an example in which optical pixels are arranged along 56 pixel columns and 192 pixel rows, the optical sensor 200 may include a SPAD array including optical pixels arranged along 56 or more pixel columns and 192 or more pixel rows. According to the LiDAR specification, the number of the pixel columns of each pixel line of the pixel lines may be changed to 18 or more and 27 or less (see FIG. 5), 28 or more (see FIG. 6), or 14 or more and 17 or less, and the like.

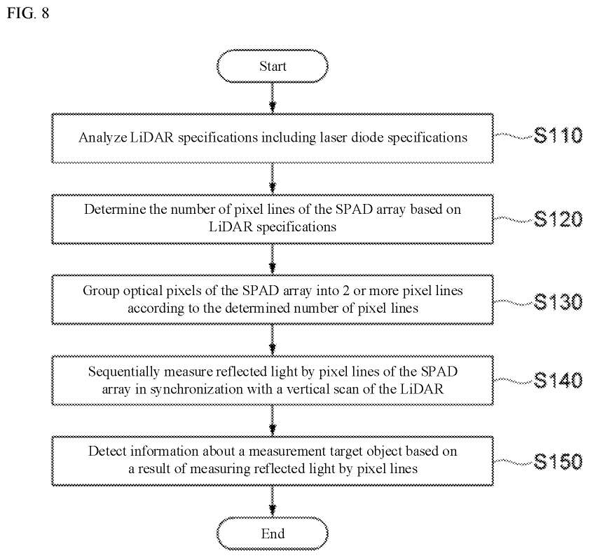

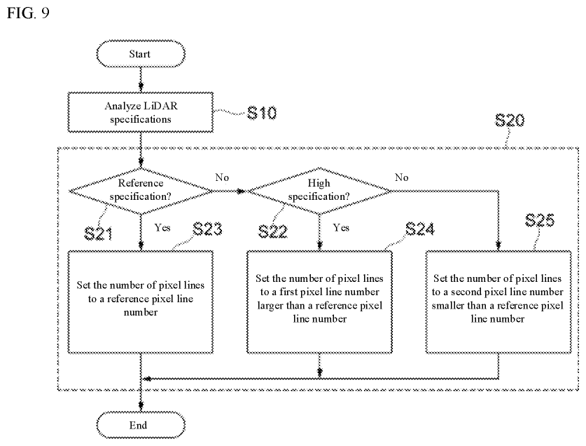

FIG. 8 is a flowchart illustrating an operation of a SPAD array LiDAR according to an embodiment of the present disclosure. FIG. 9 is a flowchart illustrating a process of grouping pixel lines of a SPAD array according to a LiDAR specification in more detail. Step S10 of FIG. 9 corresponds to step S110 of FIG. 8, and step S20 of FIG. 9 corresponds to step S120 of FIG. 8. Referring to FIGS. 8 and 9, the controller 400 may analyze a LiDAR specification including a laser diode specification (S10 and S110). The LiDAR specification may include a reference specification, a high specification higher than the reference specification, and a low specification lower than the reference specification. The LiDAR specification may be analyzed based on information stored or set in relation to the laser diode or input by a user input device.

In an embodiment, the controller 400 may analyze the LiDAR specification based on LiDAR information stored in a storage unit (not shown). The LiDAR information may include, for example, a beam divergence angle, energy density (Energy per Pulse), a pulse width, output power, and the like of the optical output unit 100. As another example, the LiDAR information may set the number of the pixel lines of the SPAD array differently according to performance of the detector 500.

When the performance of the detector 500 is within a set reference performance range, the controller 400 groups the pixel lines of the SPAD array into a reference pixel line number, and when the performance of the detector 500 falls below the reference performance range due to performance degradation, heat generation, or the like caused by long-time use, the controller 400 may reduce the number of the pixel lines of the SPAD array to be smaller than the reference pixel line number. Accordingly, by reducing a computation throughput of the detector 500, it is possible to stably detect a surrounding measurement target object in real time even with the detector 500 having low performance.

When the LiDAR specification such as the laser diode and/or detector specification is analyzed, the controller 400 may determine the number of the pixel lines of the SPAD array based on the LiDAR specification (S20 and S120). When the LiDAR specification is the reference specification, the number of the pixel lines may be set to the reference pixel line number (for example, three pixel lines) (S21 and S23). When the LiDAR specification is the high specification, the number of the pixel lines may be set to a first pixel line number (for example, four pixel lines) larger than the reference pixel line number (S22 and S24). When the LiDAR specification is the low specification, the number of the pixel lines (reference numerals 214 and 215 of FIG. 6) may be set to a second pixel line number (for example, two pixel lines) smaller than the reference pixel line number (S25).

When the pixel line number is determined according to the LiDAR specification, the optical pixels of the SPAD array may be grouped into two or more pixel lines according to the determined number of the pixel lines (S130). Thereafter, the reflected light may be sequentially measured by the pixel lines of the SPAD array in synchronization with the vertical scanning of the LiDAR by the controller 400 (S140). The detector 500 may detect the information on the measurement target object based on a result of measuring the reflected light by the pixel lines (S150).

According to the embodiment of the present disclosure as described above, various vertical angular resolutions may be implemented by the combination of the SPAD array and the vertical scanner. This is because the grouped pixel lines of the SPAD array receive reflected light signals for obtaining 3D information of measurement target regions with respect to vertical regions distinguished from each other in the second direction. Accordingly, spatial resolution may be improved by reducing angular resolution of the SPAD array to a ⅓ level while using the same number of optical pixels.

In addition, according to the embodiment of the present disclosure, since the vertical scanning of the LiDAR is implemented by dynamically setting the pixel lines of the SPAD array according to the LiDAR specification such as the laser diode specification, it is possible to implement a LiDAR satisfying a required angular resolution by the vertical scanning using the SPAD array having a small number of pixels, and simultaneously implement an angular resolution suitable for the laser diode specification, thereby improving 3D information sensing performance of the LiDAR.

According to the embodiment of the present disclosure, a Signal-to-Noise Ratio (SNR) of a long-distance signal may be improved by an increase in optical power density and energy density, as compared with a Flash type LiDAR. This is because output power can be concentrated within a narrow beam angle by scanning a single spot horizontally and vertically, and compared to the Flash type LiDAR, dispersion of output can be reduced, beam diffusion at a long distance can be reduced, the number of photons per unit area can be increased, and light receiving efficiency can be improved.

Meanwhile, the LiDAR specification may be classified into a low specification, a medium specification, and a high specification, and each specification may be classified in terms of performance, cost, and an application scenario of the LiDAR device. The LiDAR specification may be determined according to a Vertical Field of View (FoV), Horizontal Point Spacing, Vertical Point Spacing, a Number of channels, Points per second, a maximum detection range, a product height, or a SPAD type.

As an embodiment, the LiDAR specification may be determined in common for all specifications in a Horizontal FoV, a Maximum Detection Range, a Frame rate, and Maximum Continuous Power. For example, the Horizontal FoV may be determined to be 120 degrees, the maximum detection range may be determined to be 250 m within a Region of Interest (ROI) and 200 m outside the ROI, the frame rate may be determined to be 10 Hz, and the maximum continuous power may be determined to be 16 to 20 W.

As an embodiment, when the LiDAR specification is the low specification, the Vertical FoV may be 20 degrees, the Horizontal Point Spacing may be 0.05 degrees, the Vertical Point Spacing may be 0.038 degrees, the Number of channels may be 520, the Points per second may be 12.6 M, the maximum detection range may be 300 m or more, and the product height at this time may be 30 mm. A known SPAD may be used to make the LiDAR specification the low specification. In this case, according to one embodiment of the present disclosure, the number of the pixel lines in the SPAD array may be set to a number smaller than the reference pixel line number.

Alternatively, as an embodiment, when the LiDAR specification is the medium specification, the Vertical FoV may be 23.4 degrees, the Horizontal Point Spacing may be 0.05 degrees, the Vertical Point Spacing may be 0.03 degrees, the Number of channels may be 780, the Points per second may be 18.7 M, the maximum detection range may be 300 m or more, and the product height at this time may be 35 mm. In order to make the LiDAR specification the medium specification, a SPAD including an ASIC capable of reflecting some custom functions may be used, and in this case, a function of adjusting the SPAD array according to an embodiment of the present disclosure may be implemented through the ASIC. As an embodiment, a case where the LiDAR specification is the medium specification may be regarded as the reference specification according to the present disclosure.

Alternatively, as an embodiment, when the LiDAR specification is the high specification, the Vertical FoV may be 27 degrees, the Horizontal Point Spacing may be less than 0.05 degrees, the Vertical Point Spacing may be 0.025 degrees, the Number of channels may be 1080, the Points per second may be 25.92 M, the maximum detection range may be 450 m or more, and the product height at this time may be 40 mm. In order to make the LiDAR specification a high specification, a custom SPAD may be used, and in this case, according to an embodiment of the present disclosure, the number of pixel lines in the SPAD array may be set to a number greater than the reference pixel line number.

When the LiDAR specification is a low specification, a level 2 highway environment or a level 3 basic driving environment may be set as a target scenario, and a level 3 maximum speed may be determined as 60 to 80 km/h. When the LiDAR specification is a medium specification, level 2 and 3 highway environments may be set as target scenarios, and the level 3 maximum speed may be determined as 100 km/h. When the LiDAR specification is the high specification, level 2 and 3 highway environments and an urban driving environment may be set as target scenarios, and the level 3 maximum speed may be determined as 120 km/h.

Considering such LiDAR specifications, the reference pixel line number of the SPAD array LiDAR may be set, and parameter values may be changed according to each specification.

At least some of the components (e.g., the controller, the detector, etc.) of the embodiments described above may be implemented as hardware components, software components, and/or a combination of hardware components and software components. For example, the devices, methods, and components described in the embodiments may be implemented using one or more general-purpose computers or special-purpose computers, such as, for example, a processor, a controller, an Arithmetic Logic Unit (ALU), a Digital Signal Processor, a microcomputer, a Field Programmable Gate Array (FPGA), a Programmable Logic Unit (PLU), a microprocessor, or any other device capable of executing and responding to instructions.

The processing device may execute an operating system and one or more software applications running on the operating system. In addition, the processing device may access, store, manipulate, process, and generate data in response to execution of software. Although it is sometimes described that one processing device is used for convenience of understanding, those skilled in the art will understand that the processing device may include a plurality of processing elements and/or a plurality of types of processing elements.

For example, the processing device may include a plurality of processors or one processor and one controller. In addition, other processing configurations, such as a parallel processor, are also possible. The software may include a computer program, code, instructions, or a combination of one or more thereof, and may configure the processing device to operate as desired, or may instruct the processing device independently or collectively.

The software and/or data may be embodied in any type of machine, component, physical device, virtual equipment, or computer storage medium or device in order to be interpreted by the processing device or to provide instructions or data to the processing device. The software may be distributed over networked computer systems so that it may be stored or executed in a distributed manner. The software and data may be stored in one or more computer-readable recording media.

The method according to the embodiment may be implemented in the form of program instructions that can be executed through various computer means and recorded in a computer-readable medium. The computer-readable medium may include program instructions, data files, data structures, and the like, alone or in combination. The program instructions recorded on the medium may be those specially designed and configured for the embodiment, or may be those known and available to those skilled in the computer software art.

Examples of the computer-readable recording medium include magnetic media such as a hard disk, a floppy disk, and a magnetic tape, optical media such as a CD-ROM and a DVD, and hardware devices specially configured to store and execute program instructions, such as a ROM, a RAM, and a flash memory. Examples of the program instructions include not only machine language code such as that produced by a compiler, but also high-level language code that can be executed by a computer using an interpreter or the like. The hardware device described above may be configured to operate as one or more software modules to perform the operations of the embodiments, and vice versa.

The above description is for illustrative purposes, and those skilled in the art to which the present disclosure pertains will understand that the present disclosure can be easily modified into other specific forms without changing the technical spirit or essential features of the present disclosure. Therefore, the embodiments described above should be understood as illustrative in all respects and not limiting. For example, each component described as an integrated form may be implemented by being divided into a plurality of elements, and similarly, components described as a plurality of elements may also be implemented in an integrated form.

Components of various embodiments may be implemented in combination with each other as long as they do not conflict with each other. Accordingly, it should be understood tha t new embodiments in which the various embodiments described above are combined are also included in the present disclosure. The scope of the right of the present disclosure is indicate d by the claims to be described later rather than the detailed description above, and all change s or modified forms derived from the meaning and scope of the claims and the concept of equ ivalents thereof should be construed as being included in the scope of the right of the present disclosure.

### REFERENCE NUMERALS

1: Vehicle
10: SPAD Array LiDAR
100: Optical output unit
200: Optical sensor
210: SPAD array
211, 212, 213: Pixel lines
214, 215: Pixel lines
216, 217, 218, 219: Pixel lines
300: Scanner
310: Horizontal scanner
320: Vertical scanner
400: Controller
500: Detector

1. A SPAD array LiDAR comprising: an optical output unit configured to output laser light toward a measurement target object to recognize the measurement target object;
an optical sensor including a Single Photon Avalanche Diode (SPAD) array configured to detect reflected light of the laser light reflected from the measurement target object; and
a scanner configured to scan-drive the laser light and the reflected light, wherein
the scanner includes:
a horizontal scanner configured to scan-drive the laser light and the reflected light in a horizontal scanning direction; and
a vertical scanner configured to scan-drive the laser light and the reflected light in a vertical scanning direction, wherein
the SPAD array includes optical pixels arranged in a plurality of pixel rows and a plurality of pixel columns along the horizontal scanning direction and the vertical scanning direction, wherein
the optical pixels are grouped into N pixel lines along the vertical scanning direction, N being an integer of 2 or more, and wherein
N, which is the number of the pixel lines, is dynamically set according to a LiDAR specification including a laser diode specification.

2. The SPAD array LiDAR of claim 1, wherein
the pixel lines are grouped such that each pixel line includes optical pixels arranged in M consecutive pixel columns, M being an integer of 2 or more.

3. The SPAD array LiDAR of claim 1, wherein
the pixel lines do not overlap each other in the horizontal scanning direction of the scanner, and the pixel lines are divided such that no pixel column remains between adjacently arranged pixel lines.

4. The SPAD array LiDAR of claim 1, wherein
the pixel lines are activated by being sequentially synchronized with N consecutive vertical scanning periods, N being an integer of 2 or more.

5. The SPAD array LiDAR of claim 1, wherein
each pixel line includes:
active pixels arranged in a region corresponding to a sparse beam among optical pixels arranged along the horizontal scanning direction and activated for distance measurement with respect to the measurement target object; and
spare pixels arranged in a region not corresponding to the sparse beam.

6. The SPAD array LiDAR of claim 5, wherein
the pixel lines are configured such that the active pixels sequentially activated according to a vertical scan do not overlap each other in the vertical scanning direction between the pixel lines.

7. The SPAD array LiDAR of claim 5, wherein
the spare pixels are configured to receive an external light signal, and the external light signal is used as preprocessing data for noise reduction.

8. The SPAD array LiDAR of claim 5, wherein
a ratio of the active pixels among the optical pixels of each grouped pixel line is set to be inversely proportional to the number of the grouped pixel lines.

9. The SPAD array LiDAR of claim 1, wherein
the SPAD array is configured such that the number of the pixel lines is variably set to 2, 3, or 4 or more according to the LiDAR specification.

10. The SPAD array LiDAR of claim 1, wherein
the LiDAR specification includes a reference specification, a high specification higher than the reference specification, and a low specification lower than the reference specification.

11. The SPAD array LiDAR of claim 10, wherein
when the LiDAR specification is the reference specification, the number of the pixel lines is set to a reference pixel line number;
when the LiDAR specification is the high specification, the number of the pixel lines is set to a first pixel line number larger than the reference pixel line number; and
when the LiDAR specification is the low specification, the number of the pixel lines is set to a second pixel line number smaller than the reference pixel line number.

12. The SPAD array LiDAR of claim 10, wherein
when the LiDAR specification is the reference specification, the optical pixels are grouped into three pixel lines;
when the LiDAR specification is the low specification, the optical pixels are grouped into two pixel lines; and
when the LiDAR specification is the high specification, the optical pixels are grouped into four or more pixel lines.

13. The SPAD array LiDAR of claim 10, wherein
the number of optical pixels included in each grouped pixel line when the LiDAR specification is the low specification is greater than the number of optical pixels included in each grouped pixel line when the LiDAR specification is the reference specification.

14. The SPAD array LiDAR of claim 10, wherein
the number of optical pixels included in each grouped pixel line when the LiDAR specification is the high specification is smaller than the number of optical pixels included in each grouped pixel line when the LiDAR specification is the reference specification.

15. The SPAD array LiDAR of claim 10, wherein
the laser diode specification is determined based on at least one of a beam divergence angle, energy density, a pulse width, and output power of the optical output unit.

16. The SPAD array LiDAR of claim 15, wherein
the LiDAR specification is determined based on
a beam divergence angle of the laser diode, energy density, a pulse width, output power, a Vertical Field of View (FoV), Horizontal Point Spacing, Vertical Point Spacing, a Number of channels, Points per second, a maximum detection range, and a type of the SPAD array.

17. The SPAD array LiDAR of claim 1, further comprising
a controller configured to control the optical sensor, wherein
the controller sets the number of the pixel lines according to the LiDAR specification including the laser diode specification and performance of a detector.

18. The SPAD array LiDAR of claim 17, wherein
the controller:
groups the pixel lines into a reference pixel line number when the performance of the detector is within a set reference performance range; and
decreases the number of the grouped pixel lines to be smaller than the reference pixel line number when the performance of the detector is lowered below the reference performance range.

19. A vehicle equipped with the SPAD array LiDAR according to claim 1.

20. A method of controlling a SPAD array LiDAR including an optical output unit, an optical sensor, and a scanner, the method comprising:
outputting, by the optical output unit, laser light toward a measurement target object to recognize the measurement target object;
sensing, by the optical sensor including a Single Photon Avalanche Diode (SPAD) array, reflected light of the laser light reflected from the measurement target object; and
scanning, by the scanner, the laser light and the reflected light, wherein
the scanner includes:
a horizontal scanner configured to scan-drive the laser light and the reflected light in a horizontal scanning direction; and
a vertical scanner configured to scan-drive the laser light and the reflected light in a vertical scanning direction, wherein
the SPAD array includes optical pixels arranged in a plurality of pixel rows and a plurality of pixel columns along the horizontal scanning direction and the vertical scanning direction, wherein
the method further comprising grouping, by a controller including at least one processor, the optical pixels into N pixel lines along the vertical scanning direction, N being an integer of 2 or more, wherein N, which is the number of the pixel lines, is dynamically set according to a LiDAR specification including a laser diode specification.
